(19) United States
(12) Patent Application Publication
(10) Pub. No.: US 2003/0196330 A1
(43) Pub. Date: Oct. 23, 2003

(54) Manual safety straight razor having doubled-sided blades

(76) Inventor: Haruyuki Kitano, Utsunomiya (JP)

Correspondence Address: WENDEROTH, LIND & PONACK, L.L.P., 2033 K STREET N. W., SUITE 800, WASHINGTON, DC, 20006-1021, US

(21) Appl. No.: 10/251,807

(22) Filed: Sep. 23, 2002

(30) Foreign Application Priority Data
Apr. 22, 2002 (JP) NO.118741/2002

(51) Int. Cl. B26B 21/12

(52) U.S. Cl. 30/53; 30/50; 30/32; 30/30

(57) ABSTRACT

A manual straight razor comprises an elongated front cutter portion having a rear portion; the front cutter portion having an elongated wide opening which is slightly, downwardly narrowed, a complementary razor holding structure snugly inserted into the wide opening and a V-shaped lower member having a rounded end portion, along which a number of grooves are provided. When the razor structure attached with a pair of razor blades is snugly inserted into the wide opening, a pair of gaps is formed between the razor blades and the V-shaped lower member. Introduced through the grooves and kept temporarily in the gaps are soapsuds, which are rinsed away in flowing water or liquid medicine. A correct angle of inclination of a line linking the lowest point on each respective razor blade and the lowest point on the rounded elongated lower member can be easily selected into between 20 and 30 degrees to fit the razor blades on the face of the skin for safe shaving of hair.

### BACKGROUND OF THE INVENTION

1. Field of the Invention

This application is an improvement of the parent application of U.S. patent application Ser. No. 09/983,282 filed Oct. 23, 2001. This invention relates to a manual straight razor having double-sided razor blades, and more particularly to an in-line double-sided straight razor blades having dual razor-sharp cutting edges positioned front and rear guards which can easily be used both by professionals and at-home users either by pulling or pushing a razor blade strip for precise and safe shaving of hair from the face and other body regions.

2. Description of the Prior Art

There are different kinds of razors, such as professional use, home use or disposable razors on the market. Since a sharp blade of a razor is used in direct contact with the skin to remove hair from the skin, vigilant attention must be given to shaving.

In order to avoid a possible accidental cut, nick or scrape when using a straight razor especially when in the hands of home users rather than a professional such as a barber or beautician, T-bar razors have been widely used and are still in use.

Since the advent of blood-infected communicable diseases such as AIDS, the HIV virus, hepatitis and other serious diseases, there is a serious social problem.

Even trained professional such as barbers or beauticians will from time to from accidentally cut, nick or scrape the skin of their customers with razors, causing some minor bleeding.

Barbers, beauticians and healthcare workers are reluctant to come into contact with blood from others, and tend to avoid tasks where such contact is likely.

Under the above circumstances, sharpening a razor blade edge of a Western manual straight razor on a razor strop or a whetstone has been remarkably decreased and special sterilization by a public health center has recently been made obligatory for professional razors used in barbershops or beauty parlors.

In the barbershops or beauty parlors, the used razors are usually or disinfected in a sterilization chamber or sterilized in a disinfectant including invert soap, disinfecting ethanol etc.

In order to avoid an accidental cut, nick or scrape of the skin, vigilant attention from the skilled barber or beautician is not sufficient and so a safety razor with which such accidental cuts are not possible is required.

It is usual for a barber or beautician to shave a face with a razor which is pulled or pushed into a fan-like or arch-like direction by a wrist motion.

This inventor has proposed the manual straight razor having double-sided razor blades (Japanese Patent Application No. 234215/2001). An elongated wide opening is formed longitudinally in an upper part of the elongated front handle portion. The insides of an elongated rectangular wide opening and the corresponding insides of a complementary razor holding structure are in parallel with each other so that a pair of razor blades is likely off the elongated rectangular wide opening of the holder.

Conventionally fixed at the holder is the razor blade, only the front edge of which is used, and when the front portion has lost its edge, the razor blade itself is scrapped and has to be exchanged with a new one.

When the straight edge of a razor blade is laid down, long or short mustache cannot be shaved efficiently.

The soapsuds containing shaved hair and mustache, scratch and sebaceous matter are clogged into the gaps between the sides of the elongated rectangular wide opening and those of the complementary razor holding structure, thus making the razor blade to lose its edge.

The double-sided straight razor of this invention is based on the applicant's long experience as a barber from which he has realized that an angle inclination (relative to the skin surface) of the line linking the lowest point of a rounded end of a support for the blade, which contacts the skin, must take an angle between 20 and 30 degrees when the razor blade extends perpendicular to the skin.

It should be understood that in case the angle of inclination of the line linking the lowest point on a blade edge of a razor and the point of the support which is in contact with the skin is less than 20 degrees relative to the skin surface when the blade extends perpendicular thereto, a shaving angle of the blade edge in use is too low so that it scrapes the skin, thus causing insufficient shaving of facial hair, and in case the inclination angle is over 30 degrees, the blade edge presents a sharp edge and so can cut the skin accidentally.

(1) U.S. Pat. No. 6,164,290 Edward A. Andrews discloses a double-sided straight razor blades having dual razor-sharp cutting edges positioned at front and rear guards, and an in-line handle, which can easily be gripped for precise shaving of the face and other body regions.

This double-sided straight razor has four razor strips, which cannot be used both for pull and push shavings.

(2) The Japanese Patent Publication No. 114246/1999 (not examined) discloses a change blade-type razor and a method of shaving the face and other body regions whereby a safe and slant shaving can be easily carried out even by an unskilled user.

(3) The Japanese Patent Publication No. 277369/1994 (not examined) shows a wet-type razor device 1 which comprises a long handle portion, and a shaving portion mounted to the long handle portion by fixing parts for shaving hair from the face and other body regions.

(4) The Japanese Utility Model Publication No. 11674/1994 (not examined) discloses a safety razor having double-sided straight razor blades which comprises a handle portion, an elongated from cutter portion, and a pair of razor blades provided at both portions of a back portion of the front cutter portion, which is characterized in that a plane linking the belly of the front cutter portion extending to the back portion including a pair of razor blade strips and a plane linking the razor blade strips and the back portions are substantially in parallel with each other,

(5) The razor shown in the Japanese Utility Model Publication No. 104770/1987 (not examined) has a handle portion, a pair of connecting portions, a pair of support portion, a pair of blade strips held into the support portions, a sponge inserted into between the blade strips and the support portions.

(6) The razor holder described in the Japanese Utility Model Publication No. 104770/1987 (not examined) includes a handle portion having a holder, which comprises a groove whereby a razor blade strip can be easily made.

### SUMMARY AND OBJECTS OF THE INVENTION

A principal object of this invention is to provide a manual safety straight razor having double-sided blades that can easily be gripped both by professionals and home users for easy, precise and safe shaving of hair from the face and other body regions.

Another object of this invention is to provide a manual safety straight razor having double-sided blades whereby an accidental cut, nick or scrape of the skin can be avoided to prevent infection of blood-infected communicable diseases such as AIDS, the HIV virus, hepatitis and other serious diseases.

Another object of this invention is to provide a manual safety straight razor having double-sided blades whereby the angle of inclination of a line linking the lowest point on each respective razor blade and the lowest point on a rounded elongated lower member portion is between 20 and 30 degrees in order to fit the razor blades on the face of the skin with a shallow angle of inclination for shaving.

Another object of this invention is to provide a manual safety straight razor having double-sided blades whereby both of the angles of inclination of lines linking the razor blade of the razor blades and a rounded elongated lower member portion of a complementary razor holding structure is between 20 and 30 degrees in order to enable a user either to pull or push the razor blades on the surface of a skin.

Another object of this invention is to provide a manual safety straight razor having double-sided blades wherein a number of paralleling, arched or slanting grooves are provided along a rounded V-shaped lower member of a complementary razor holding structure whereby the soapsuds containing shaved hair and mustache, scratch and sebaceous matter are introduced through these grooves and kept temporarily in the gaps between a pair of two razor blades and the V-shaped lower member in order not to lose the edge of the razor blade.

Another object of this invention is to provide a manual safety straight razor having double-sided blades whereby the soapsuds containing shaved hair and mustache, scratch and sebaceous matter which are temporarily kept in the gaps between a pair of two razor blades and the V-shaped lower member can be easily rinsed away in flowing water or liquid medicine in order not to lose the edge of the razor blade.

Another object of this invention is to provide a manual safety straight razor having double-sided blades wherein the soapsuds containing shaved hair and mustache, scratch and sebaceous matter are not clogged around a pair of two razor blades and the V-shaped lower member in order not to lose the edge of the razor blade.

Another object of this invention is to provide a manual safety straight razor having double-sided blades whereby a pair of razor blades is not off the elongated rectangular wide opening of the holder.

Another object of this invention is to provide a manual safety straight razor having double-sided blades whereby front and rear portions of the razor blades can easily be turned around just likely to draw a figure of ∞ in order to extend the life of the razor blade.

Another object of this invention is to provide a manual safety straight razor having double-sided blades whereby a front portion of the razor blade can easily be changed by arranging it in the opposite direction in order to extend the life of the razor blade.

Another object of this invention is to provide a manual safety straight razor having double-sided blades which can easily be used both by professionals and home users either by pulling or pushing the razor for easy, precise and safe shaving of hair from the face and other body regions.

Another object of this invention is to provide a manual safety straight razor having double-sided blades which can easily be pulled or pushed by a wrist motion of a user.

Another object of this invention is to provide a manual safety straight razor having a fingertip dent a neck portion of an elongated front cutter portion whereby a complementary razor holding structure attached with a pair of razor blades on both sides of the structure can easily be slid into or pulled out of an elongated wide opening of the elongated front cutter portion.

Another object of this invention is to provide a manual safety straight razor having double-sided blades whereby a correct angle of inclination of a pair of razor blades can easily be selected to a face or other body regions.

Another object of this invention is to provide a manual safety straight razor having double-sided blades, which is simple in construction, so that it can be made easily.

Still another object of this invention is to provide a manual safety straight razor having double-sided blades whereby many individuals prefer to use the professional services of a barber or beautician of a facial shaving without anxiety

### BRIEF DESCRIPTION OF THE DRAWINGS

This object and features of the invention will become apparent from the following description taken in conjunction with the preferred embodiment thereof with reference to the accompanying drawing, in which:

FIG. 1 is a perspective view schematically showing a manual safety straight razor having double-sided blades according to this invention, which is being held by a hand for shaving;

FIG. 2 is a front view of the manual safety straight razor shown in FIG. 1;

FIG. 3 is a perspective view of the manual safety straight razor shown in FIG. 2, showing that a complementary razor holding structure mounted with a pair of razor blades is being pulled out into a front direction;

FIG. 4 is a perspective view of the manual safety straight razor showing that an elongated front cutter handle portion is folded into a rear handle portion;

FIG. 5 is an exploded perspective view showing that the exploded parts of the manual safety straight razor shown in FIGS. 1˜4 are being assembled;

FIG. 6 is a partially enlarged sectional fragmentary view of a front portion of a double-sided cartridge, taken along line V1-V1, of a manual safety straight razor shown in FIGS. 5;

FIG. 7 is a partially enlarged sectional fragmentary view of a complementary razor holding structure, taken along line V11-V11, of a manual safety straight razor shown in FIGS. 5;

FIG. 8 is a partially enlarged front view of a complementary razor holding structure showing a number of paralleling grooves provided along a rounded elongated lower member portion of the complementary razor holding structure;

FIG. 9 is a partially enlarged front view of a complementary razor holding structure showing a number of arched grooves provided along a rounded elongated lower member portion;

FIG. 10 is a partially enlarged front view of a complementary razor holding structure showing a number of slanting grooves provided along a rounded elongated lower member portion;

FIG. 11 is a partially enlarged sectional view, taken along line X1-X1 of a longitudinal cutter head portion and a complementary razor holding structure which are vertically fitted on the surface of a face;

FIG. 12 is an enlarged schematic longitudinal sectional view of the manual safety razor which is vertically fitted on the surface of a face; and

FIG. 13 is an enlarged schematic longitudinal sectional view of the manual safety razor which is fitted on the surface of a face at a given angle for shaving hair.

### DETAILED DESCRIPTION OF THE PREFERRED EMBODIMENT

Referring now to the accompanying drawings in which like numerals designate like parts throughout the several views thereof, there are shown in FIGS. 1˜4, a manual safety straight razor 10 having double-sided blades of this invention comprises an elongated front cutter portion 12 and an elongated rear handle portion 30 which is pivotally and rotationally secured to a rear portion of the elongated front cutter portion 12.

The elongated rear handle portion 30 has a pair of dog-deformed plates 30a, 30a which are joined together by a bolt 32, nut 34, washers 36 and a ring 38.

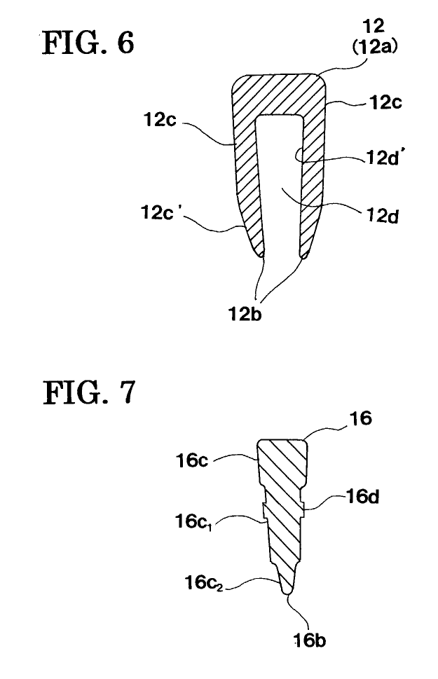

As shown in FIGS. 5 and 6, the elongated front cutter portion 12 has a longitudinal cutter head portion 12a, an elongated wide opening 12d for holding a complementary razor holding structure 16 therein and a pair of first exposed surfaces 12c, 12c which are slightly, downwardly narrowed, and a pair of second exposed surfaces 12c′, 12c′ which are further narrowed and curved into a pair of narrow wedge portions 12b, 12b which are spaced from each other to form a narrow wedge portion.

FIG. 7 is a partially enlarged sectional fragmentary view of a complementary razor holding structure 16 which includes a pair of first slightly, downwardly narrowed surfaces 16c, 16c corresponding to the inner faces of the elongated wide opening 12d, a pair of longitudinal grooves 16c₁, 16c₁, a plurality of projections 16d, 16d provided longitudinally with a given interval and a V-shaped lower member 16c₂ having a rounded end portion 12b which are brought into contact with the inner faces 12d′, 12d′ of the elongated wide opening 12d.

The complementary razor holding structure 16 attached with the razor blades 20, 20 on either side is snugly inserted into the elongated wide opening 16b so that a pair of gaps 22, 22 is formed between the razor blades 20, 20 and the V-shaped lower member 16c.

In FIG. 5, the projections 16c₂, 16c₂ of the complementary razor holding structure 16 are inserted into the grooves 20b of the razor blades 20 for interlocking the razor blades 20.

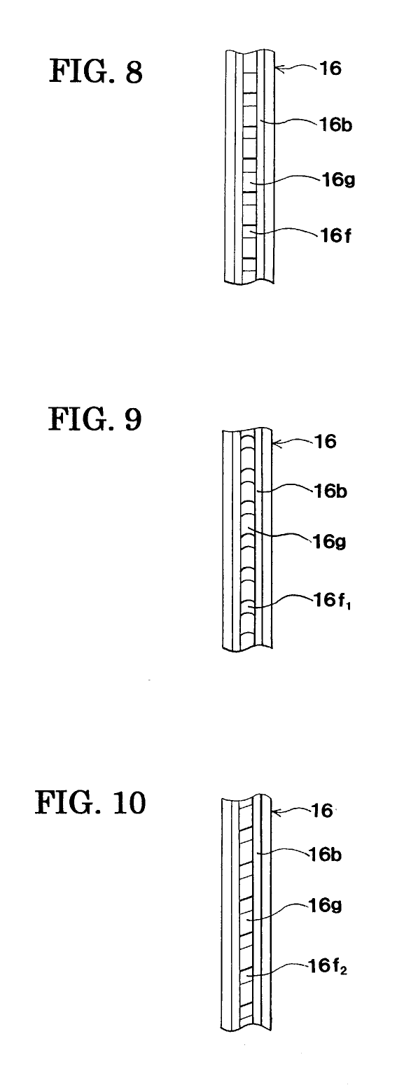

As shown in FIG. 8, a manual safety straight razor 10 has a number of parallel grooves 16f, 16f which are provided longitudinally with a given interval 16g along the V-shaped lower member 16b whereby the soapsuds containing shaved hair and mustache, scratch and sebaceous matter are introduced through the parallel grooves 16f, 16f and kept temporarily in the gaps 22, 22 between the sides of the elongated rectangular wide opening 12d and those of the complementary razor holding structure 16.

In FIG. 9, a manual safety straight razor 10 has a number of arched grooves 16f₁, 16f₁ which are provided longitudinally with a given interval 16g along the V-shaped lower member 16c whereby the soapsuds containing shaved hair and mustache, scratch and sebaceous matter are introduced through the arched grooves 16f₁, 16f₁ and kept temporarily in the gaps 22, 22 between the sides of the elongated rectangular wide opening 12d and those of the complementary razor holding structure 16.

As shown in FIG. 10, a manual safety straight razor 10 has a number of slanting grooves 16f₂, 16f₂ which are provided longitudinally with a given interval 16g along the V-shaped lower member 16c whereby the soapsuds containing shaved hair and mustache, scratch and sebaceous matter are introduced through the slanting grooves 16f₂, 16f₂ and kept temporarily in the gaps 22, 22 between the sides of the elongated rectangular wide opening 12d and those of the complementary razor holding structure 16.

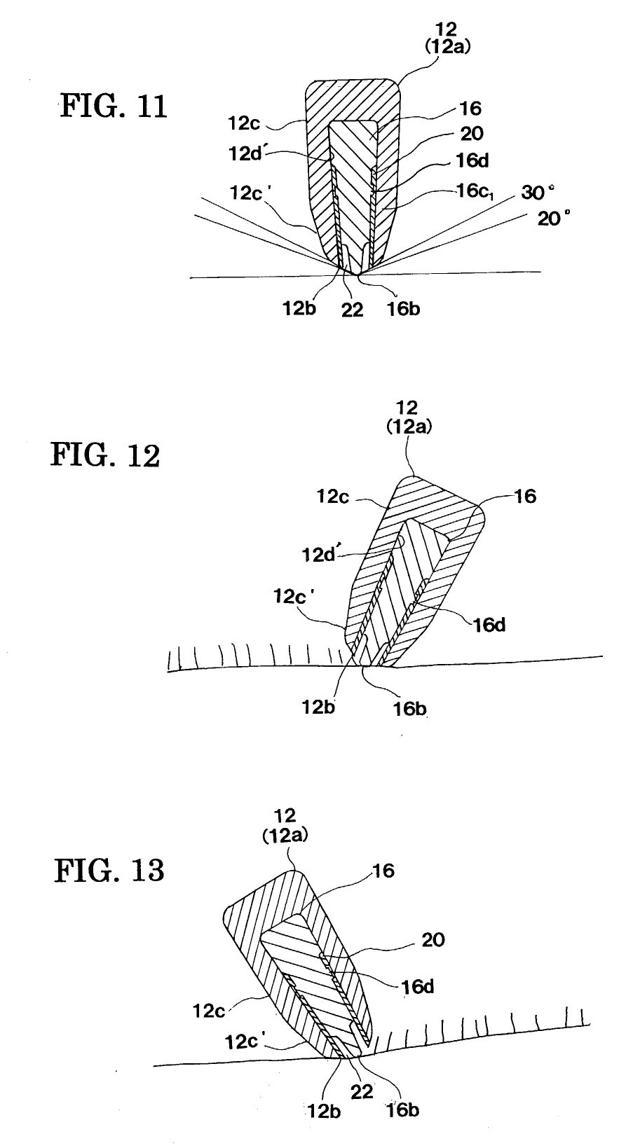

In FIGS. 5 and 11, a pair of razor blades 20, 20, each blade having a plurality of slits 20b corresponding to the projections 16d, 16d, is detachably mounted on both of the narrowed surface 16c, 16c of the complementary razor holding structure 16, thus inserting the projections 16d, 16d into the grooves 20b, 20b respectively.

Accordingly, when the complementary razor holding structure 16 is mounted into the elongated wide opening 12d, an imaginary V-shaped working plane is formed by a pair of an imaginary line (at between 20 degrees and 30 degrees to the skin surface linking the lowest point on the rounded end 16b and the lowest point 12b of the razor blade 20 when the manual safety razor 10 is not inclined (i.e. when the manual safety razor 10 is held so that the elongated lower portion 16c extends perpendicular to the skin surface).

It should be appreciated that the angle between the lowest point on the rounded end 16b and the lowest point 12b of the razor blade 20 will always be between 20 and 30 degrees when the manual safety razor 10 is not inclined.

As mentioned in the foregoing paragraphs, a front portion of the edge of the razor blade 20 is easily lost so that it is preferable to turn around the front portion with the rear portion of the razor blade 20 just like to draw a figure of ∞, thus extending the life of the razor blade.

At the same time, a front portion of the razor blade 20 can easily be changed by arranging it in the opposite direction in order to extend the life of the razor blade.

The most important feature of this invention is that the manual safety straight razor has double-sided blades wherein a number of paralleling, arched or slanting grooves 16f, 16f₁ or 16f₂ are provided along the rounded V-shaped lower member 16b of the complementary razor holding structure 16 whereby the soapsuds containing shaved hair and mustache, scratch and sebaceous matter are introduced through these grooves 16f, 16f₁ or 16f₂ and kept temporarily in the gaps 22, 22.

It is very easy for the user to rinse away the soapsuds containing shaved hair and mustache, scratch and sebaceous matter which are kept temporarily in these gaps 22, 22 in flowing water or liquid medicine.

Accordingly, it is not necessary to suspend shaving hair of a customer for sharpening on a strop or whetstone when an edge of a razor blade has been lost by the clogged soapsuds on or around the edge of the razor blade.

It is also to be appreciated that the longitudinal cutter head portion 12a of the elongated head portion 12 has an elongated wide opening 12d which is slightly, downwardly narrowed, and the complementary razor holding structure 16 having a pair of the razor blades 20, 20 is snugly slid into the elongated wide opening 12d so that the razor blades 20, 20 are not disengaged.

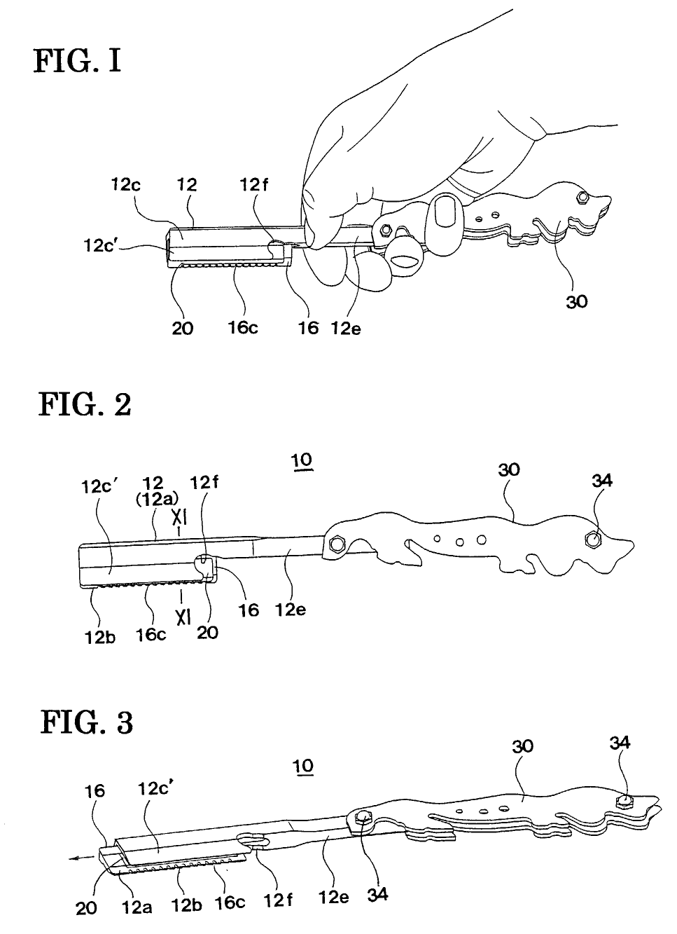

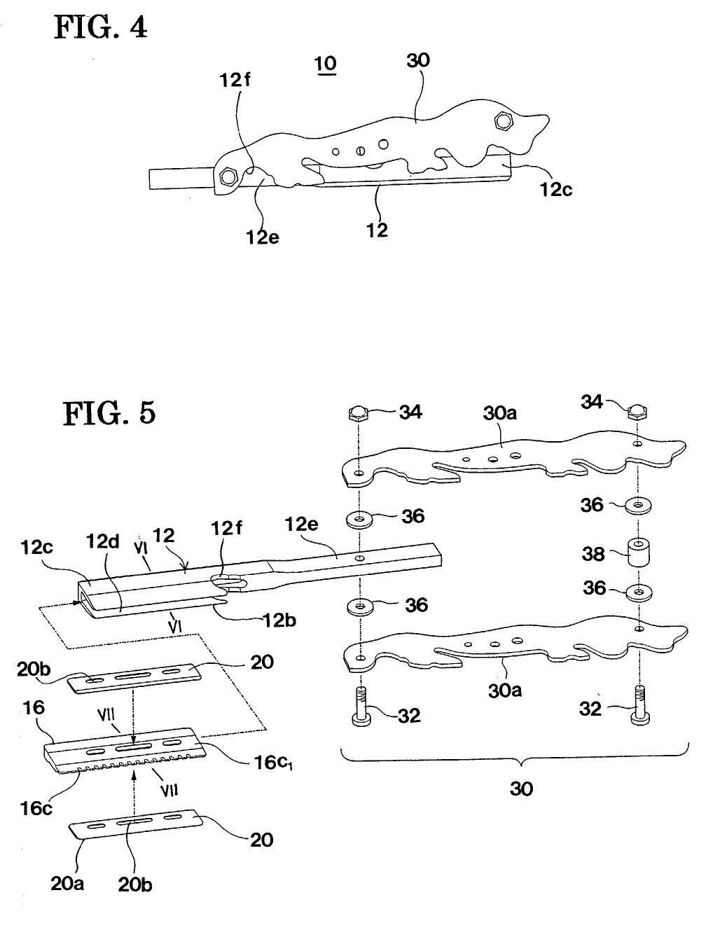

As described in FIGS. 1, 2, 3 and 5, the manual safety straight razor 10 has a fingertip dent 12f at a neck portion of an elongated front cutter portion 12 so that the complementary razor holding structure 16 attached with a pair of razor blades 20, 20 on both sides of the structure 16 can easily be slid into or pulled out of the elongated wide opening 12d of the elongated front cutter portion 12.

In practice, the user places the elongated lower portion 16c of the manual safety razor 10 on to the skin so that the razor blades 20, 20 extend vertically (i.e. perpendicular to the skin), and subsequently manual safety razor 10 is inclined onto the surface of the skin.

In view of the fact that the angle of inclination of lines linking the razor blade edge 20a, 20a of the razor blades 20, 20 and the rounded end 16b is always between 20 and 30 degrees when the manual safety razor 10 is not inclined, the razor blades 20, 20 are fitted softly at a suitable angle to the surface of the skin so that easy, safe and reliable shaving of hair from the surface of the skin can be carried out not only by a barber or beautician, but also by an unskilled user.

At the same time, both pulling and pushing motions of the inclined outer face of the razor blade edges 20a, 20a can be carried out easily and freely by the wrist motion of a user.

It is to be understood that the in-line safety straight razor of this invention is by no means limited to the particular construction and uses herein described, disclosed and/or shown in the drawing.

It should be understood, of course, that the specific form of the invention herein illustrated and described is intended to be representative only, as certain changes may be made therein without departing from the clear teachings of the disclosure. Accordingly, reference should be made to the following appended claims in determining the full scope of the invention.

I claim:

1. A manual safety straight razor having doubled-sided blades which comprises:
an elongated front cutter portion having a dog-deformed rear handle portion which is pivotally and rotationally secured to a rear portion of said elongated front cutter portion, said dog-deformed rear handle portion having a pair of dog-deformed plates which are joined together by a bolt, nut, washers and a ring;
said elongated front cutter portion having a longitudinal cutter head portion, an elongated wide opening, a pair of first exposed surfaces which are slightly, downwardly narrowed, and a pair of second exposed surfaces' which are further narrowed and curved into a pair of narrow wedge portions which are spaced from each other to form a narrow wedge portion;
a complementary razor holding structure which includes a pair of first slightly, downwardly narrowed surfaces corresponding to the inner faces of said elongated wide opening, a pair of longitudinal grooves, a plurality of projections provided longitudinally with a given interval and a V-shaped lower member having a rounded end portion which are brought into contact with the inner faces of said elongated wide opening, and said V-shaped lower member having a number of parallel grooves along said rounded end and curved into a narrow wedge portions which are spaced from each other to form a wedge portion;
a pair of razor blades attached on either side face of said complementary razor holding structure, each blade having a plurality of grooves provided longitudinally to correspond to the projections of said projections of the complementary razor holding structure;
which is characterized in that when the complementary razor holding structure attached with a pair of said razor blades is snugly inserted into the elongated wide opening, a pair of gaps are formed into between the razor blades and the V-shaped lower member to form an imaginary V-shaped working plane formed by a pair of two imaginary lines.

2. A manual safety straight razor having doubled-sided blades as claimed in claim 1, which is characterized in that when the complementary razor holding structure attached with a pair of said razor blades is snugly inserted into the elongated wide opening, the razor blades are so arranged to direct the inclined flat cutting portions of the razor blades symmetrically and inwardly to form an imaginary V-shaped working plane, and that the angle of inclination of lines linking edges of the razor blades and said rounded lower member portion of said razor structure is between 20 to 30 degrees when the razor blades are fitted to the surface of a skin.

3. A manual safety straight razor having doubled-sided blades as claimed in claim 1, which is characterized in that a number of paralleling grooves are provided along the rounded V-shaped lower member of the complementary razor holding structure whereby the soapsuds containing shaved hair and mustache, scratch and sebaceous matter are introduced through these paralleling grooves and kept temporarily in the gaps between a pair of two razor blades and the V-shaped lower member.

4. A manual safety straight razor having doubled-sided blades as claimed in claim 1, which is characterized in that a number of arched grooves are provided along the rounded V-shaped lower member of the complementary razor holding structure whereby the soapsuds containing shaved hair and mustache, scratch and sebaceous matter are introduced through these arched grooves and kept temporarily in the gaps between a pair of two razor blades and the V-shaped lower member.

5. A manual safety straight razor having doubled-sided blades as claimed in claim 1, which is characterized in that a number of slanting grooves are provided along the rounded V-shaped lower member of the complementary razor holding structure whereby the soapsuds containing shaved hair and mustache, scratch and sebaceous matter are introduced through these slanting grooves and kept temporarily in the gaps between a pair of two razor blades and the V-shaped lower member.

6. A manual safety straight razor having doubled-sided blades as claimed in claim 1, whereby the soapsuds containing shaved hair and mustache, scratch and sebaceous matter, which are kept temporarily in the gaps between a pair of the two razor blades and the V-shaped lower member, can be easily rinsed away in flowing water or liquid medicine.
